(19) United States
(12) Patent Application Publication
(10) Pub. No.: US 2026/0088224 A1
(43) Pub. Date: Mar. 26, 2026

(54) DIELECTRIC, CAPACITOR, ELECTRIC CIRCUIT, CIRCUIT BOARD, APPARATUS, AND METHOD FOR MANUFACTURING DIELECTRIC

(71) Applicant: Panasonic Intellectual Property Management Co., Ltd., Osaka (JP)

(72) Inventors: YUYA KATO, Osaka (JP); MANABU KANOU, Osaka (JP)

(21) Appl. No.: 19/361,059

(22) Filed: Oct. 17, 2025

Related U.S. Application Data
(63) Continuation of application No. PCT/JP2024/015008, filed on Apr. 15, 2024.

(30) Foreign Application Priority Data
May 12, 2023 (JP) 2023-079681

(51) Int. Cl. H01G 4/12; H01G 2/06; H01G 4/008

(52) U.S. Cl. CPC H01G 4/1254; H01G 2/065; H01G 4/008

(57) ABSTRACT

A dielectric includes a first portion and a second portion. The first portion contains tantalum oxide and tellurium and is located at a surface of the dielectric. The second portion contains tantalum oxide and is covered with the first portion. A content of the tellurium in the first portion is higher than a content of tellurium in the second portion.

### BACKGROUND

### 1. Technical Field

The present disclosure relates to a dielectric, a capacitor, an electric circuit, a circuit board, an apparatus, and a method for manufacturing a dielectric.

### 2. Description of the Related Art

Heretofore, a dielectric material containing a metal oxide has been known.

For example, Japanese Unexamined Patent Application Publication No. 2016-47797 has disclosed a dielectric which is a metal oxide material containing a glass phase. This metal oxide material is manufactured by a step of forming a sol from an epoxide, a precursor of a metal oxide, a precursor of a glass forming oxide, and a mixture composed only of solvents; a step of drying the sol to form a film; and a step of annealing this film. The Patent Document described above also has disclosed that the precursor of the metal oxide may be tantalum ethoxide, and that the glass forming oxide may be TeO₂.

### SUMMARY

In one general aspect, the techniques disclosed here feature a dielectric comprising: a first portion that contains tantalum oxide and tellurium and that is located at a surface of the dielectric; and a second portion that contains tantalum oxide and that is covered with the first portion. In the dielectric described above, a content of the tellurium in the first portion is higher than a content of tellurium in the second portion.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view showing one example of a dielectric of the present disclosure;

FIG. 2 is a cross-sectional view showing one example of a capacitor of the present disclosure;

FIG. 3 is a cross-sectional view showing another example of the capacitor of the present disclosure;

FIG. 4A is a schematic view showing one example of an electric circuit of the present disclosure;

FIG. 4B is a schematic view showing one example of a circuit board of the present disclosure;

FIG. 4C is a schematic view showing one example of an apparatus of the present disclosure;

FIG. 5 is a graph showing a measurement result of a dielectric film according to Example 2 by an x-ray photoelectron spectroscopy (XPS);

FIG. 6A is a graph showing the relationship between signal intensities of TeO⁻, TaO³⁻, and O⁻ of an dielectric film according to Example 1 measured by a time-flight secondary ion mass spectrometry (TOF-SIMS) and the depth of the dielectric film;

FIG. 6B is a graph showing the relationship between signal intensities of TeO⁻, TaO³⁻, and O⁻ of a dielectric film according to Example 2 measured by a TOF-SIMS and the depth of the dielectric film;

FIG. 6C is a graph showing the relationship between signal intensities of TeO⁻, TaO³⁻, and O⁻ of a dielectric film according to Example 3 measured by a TOF-SIMS and the depth of the dielectric film;

FIG. 6D is a graph in which the relationships shown in FIGS. 6A, 6B, and 6C each measured using the TOF-SIMS are collectively shown;

FIG. 6E is a graph in which the relationships shown in FIGS. 6A, 6B, and 6C each measured using the TOF-SIMS are collectively shown with different vertical scale;

FIG. 7A is a graph showing the relationships each between the frequency and an electrostatic capacity of a capacitor including the dielectric film, according to Example 1 and Comparative Example 1;

FIG. 7B is a graph showing the relationships each between the frequency and an electrostatic capacity of a capacitor including the dielectric film, according to Example 2 and Comparative Example 1; and FIG. 7C is a graph showing the relationships each between the frequency and an electrostatic capacity of a capacitor including the dielectric film, according to Example 3 and Comparative Example 1.

### DETAILED DESCRIPTIONS

### Underlying Knowledge Forming Basis of the Present Disclosure

Since having a high specific dielectric constant, tantalum oxide has been widely used as a dielectric material for a high performance capacitor. In recent years, in association with improvement in performance of electronic apparatuses, a capacitor having a higher electrostatic capacity has been demanded, and in a capacitor using a dielectric material containing tantalum oxide, a more increase in electrostatic capacity is also important.

In consideration of the situation as described above, the present inventors carried out intensive research on an additive component to be added to a dielectric material, the additive component being able to increase an electrostatic capacity of a capacitor using a dielectric material containing tantalum oxide. As a result, the present inventors have paid attention on the idea that tellurium is likely to generate polarization in an oxide film. Through further research carried out by the present inventors, it was found that when a content of tellurium at a specific portion of the dielectric containing tantalum oxide is higher than a content of tellurium at another portion thereof, the electrostatic capacity of a capacity using the dielectric described above is likely to increase. As a result, the present inventors invented a dielectric of the present disclosure and a capacitor using the same.

The metal oxide material disclosed in Japanese Unexamined Patent Application Publication No. 2016-47797 is manufactured by a sol-gel method, and hence, a component, such as tellurium, derived from the glass forming oxide is expected to be uniformly distributed in the entire metal oxide material described above. Hence, according to the method for manufacturing a metal oxide material described in Japanese Unexamined Patent Application Publication No. 2016-47797, to adjust the content of tellurium at a specific portion of the metal oxide material higher than the content of tellurium at another portion thereof is believed to be difficult.

According to the present disclosure, a novel dielectric containing tantalum oxide and tellurium can be provided.

### Embodiments

Hereinafter, embodiments of the present disclosure will be described with reference to the drawings. The present disclosure is not limited to the following embodiments.

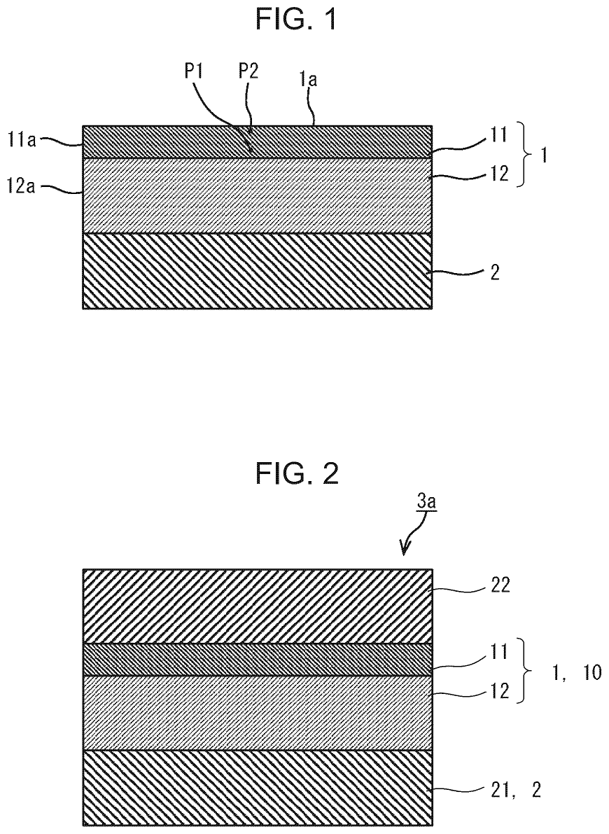

FIG. 1 is a cross-sectional view showing one example of a dielectric of the present disclosure. As shown in FIG. 1, a dielectric 1 includes a first portion 11 and a second portion 12. The first portion 11 contains tantalum oxide and tellurium and forms a surface 1a of the dielectric 1. The second portion 12 contains tantalum oxide and is covered with the first portion 11. A content of the tellurium in the first portion 11 is higher than a content of tellurium in the second portion 12. According to the structure as described above, although tellurium is not uniformly distributed in the entire dielectric 1, for example, in view of increase in electrostatic capacity of a capacitor, the dielectric 1 is likely to have advantageous characteristics. In addition, by the tellurium contained in the first portion 11, oxygen defects are not likely to occur in the dielectric 1, and in view of improvement in durability of the capacitor, the dielectric 1 is likely to have advantageous characteristics.

As shown in FIG. 1, the second portion 12 is in contact with a substrate 2. The substrate 2 is not limited to a specific substrate. The substrate 2 is, for example, an electric conductive material. The electric conductive material is, for example, metal tantalum. In this case, the substrate 2 is able to function as an electrode of the capacitor. The second portion 12 is in contact with, for example, the substrate 2 composed of metal tantalum. In this case, the dielectric 1 can be formed by anodic oxidation. The substrate 2 may also be a dielectric.

The dielectric 1 is not limited to have a specific shape. As shown in FIG. 1, the dielectric 1 is, for example, in the form of a film. In this case, the thickness of the dielectric 1 is not limited to a specific value. The thickness described above is, for example, 10 nm to 1,000 nm. The thickness of the dielectric 1 may be determined based on the result of a TOF-SIMS or may also be determined based on observation of the cross-section of the dielectric 1 using an electron microscope, such as a scanning electron microscope (SEM) and/or a transmission electron microscope (TEM). The shape of the dielectric 1 may also be in the form of particles or fibers.

As shown in FIG. 1, in the dielectric 1, for example, the first portion 11 forms a first layer 11a, and the second portion 12 forms a second layer 12a. In this case, the relationship between a thickness t₁₁ₐ of the first layer 11a and a thickness t₁₂ₐ of the second layer 12a is not limited to a specific relationship. The thickness t₁₁ₐ of the first layer is, for example, less than or equal to 24% of a sum S₁₂ of the thickness t₁₁ₐ of the first layer and the thickness t₁₂ₐ of the second layer. In the structure as described above, in view of increase in electrostatic capacity of the capacitor, the dielectric 1 is also able to have advantageous characteristics. The thickness t₁₁ₐ and the thickness t₁₂ₐ each can be determined by the measurement result of a TOF-SIMS and, for example, can be determined in accordance with a method to be described in Example.

The thickness t₁₁ₐ of the first layer 11a may also be less than or equal to 30%, 25%, 20%, or 15% of the sum S₁₂. The thickness t₁₁ₐ of the first layer is, for example, greater than or equal to 5% of the sum S₁₂.

A distribution of the content of tellurium in the first portion 11 is not limited to a specific distribution. For example, in the first portion 11, a content C_{P1} of tellurium at a first position P1 is lower than a content C_{P2} of tellurium at a second position P2. In the first portion 11, the first position P1 is a position apart from the surface 1a in a direction perpendicular thereto by a first distance. In the first portion 11, the second position P2 is a position apart from the surface 1a in a direction perpendicular thereto by a second distance. The second distance is shorter than the first distance. In the structure as described above, in view of increase in electrostatic capacity of the capacitor, the dielectric 1 is also able to have advantageous characteristics.

In the dielectric 1, in association with the increase in distance from the surface 1a in the direction perpendicular thereto, the content of tellurium may be either continuously or non-continuously decreased.

The content of tellurium in the first portion 11 is not limited to a specific value. For example, by a TOF-SIMS of the dielectric 1, the signal intensity of ions derived from tellurium is lower than the signal intensity of ions derived from tantalum oxide.

The oxidation number of tellurium contained in the first portion 11 is not limited to a specific value. The first portion 11 contains, for example, tetravalent tellurium. In this case, in the dielectric 1, the polarization caused by tellurium is likely to be increased, and in view of increase in electrostatic capacity of the capacitor, the dielectric 1 is more likely to have advantageous characteristics. In addition, in the dielectric 1, the oxygen defects are more unlikely to occur.

A method for manufacturing the dielectric 1 is not limited to a specific method. The method for manufacturing the dielectric 1 includes, for example, while metal tantalum is in contact with a solution containing tellurium, a step of performing anodic oxidation of the metal tantalum. According to the manufacturing method as described above, the dielectric 1 in which the content of tellurium in the first portion 11 is higher than the content of tellurium in the second portion 12 can be efficiently manufactured.

In the anodic oxidation of the manufacturing method described above, for example, metal tantalum is used as an anode, and platinum is used as a cathode. Between the anode and the cathode, a predetermined voltage is applied. Accordingly, anions, such as oxide ions, attracted to the metal tantalum functioning as the anode and ionized tantalum are bonded together, and as a result, the dielectric 1 containing tantalum oxide is obtained. In this case, the tellurium contained in the solution is incorporated in the dielectric. Accordingly, in a portion forming the surface of the dielectric 1, tellurium can be contained. On the other hand, although oxide ions are able to transfer to a portion of the dielectric 1 in contact with the metal tantalum, tellurium is hardly incorporated in the portion described above. Hence, although containing tantalum oxide, this portion has a very small content of tellurium.

The dielectric 1 may also be manufactured by a method other than the anodic oxidation, such as a sputtering method. In this case, as a material of the substrate 2, a material other than metal tantalum may also be used.

By the use of the dielectric 1, for example, a capacitor can be provided. FIG. 2 is a cross-sectional view showing one example of a capacitor of the present disclosure. As shown in FIG. 2, a capacitor 3a includes a first electrode 21, a second electrode 22, and a dielectric film 10. The dielectric film 10 contains the dielectric 1 and is disposed between the first electrode 21 and the second electrode 22. According to the structure as described above, the capacitor 3a is likely to have a high electrostatic capacity.

As shown in FIG. 2, the first electrode 21 is in contact with the second portion 12 of the dielectric 1. In addition, the first portion 11 is disposed between the second portion 12 and the second electrode 22 in the thickness direction of the dielectric film 10.

The first electrode 21 contains, for example, metal tantalum. In this case, by the anodic oxidation using a solution containing tellurium, the capacitor 3a can be manufactured. The first electrode 21 may be an electric conductor other than metal tantalum.

A material of the second electrode 22 is not particularly limited as long as having electric conductivity. The second electrode 22 may contain a valve metal, such as aluminum, tantalum, niobium, or bismuth, a noble metal, such as gold or platinum, or nickel. The second electrode 22 may also contain a carbon material, such as graphite.

In the capacitor 3a, the surface 1a of the dielectric 1 may be in contact with an electrolyte. In this case, the second electrode 22 may contain an electrolyte. This electrolyte is not limited to a specific electrolyte. The electrolyte includes, for example, at least one selected from the group consisting of an electrolyte solution, a solid electrolyte, and an electric conductive polymer. As an example of the electric conductive polymer, there may be mentioned a polypyrrole, a polythiophene, a polyaniline, or a derivative thereof. As the electrolyte, a manganese compound such as manganese oxide may also be used.

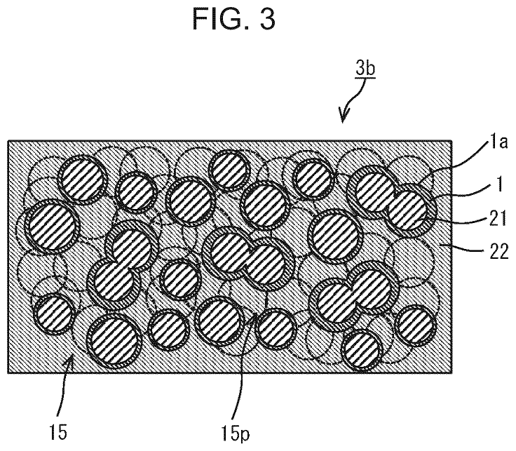

FIG. 3 is a cross-sectional view showing another example of the capacitor of the present disclosure. A capacitor 3b shown in FIG. 3 is formed in a manner similar to that of the capacitor 3a except for portions to be particularly described. Constituent elements of the capacitor 3b which are the same as or corresponding to the constituent elements of the capacitor 3a are designated by the same reference numerals, and detailed description thereof will be omitted. The description of the capacitor 3a can also be applied to that of the capacitor 3b as long as no technical contradictions exist.

As shown in FIG. 3, in the capacitor 3b, the dielectric 1 and the first electrode 21 collectively form a porous body 15. The second electrode 22 fills a space 15p around the porous body 15. According to the structure as described above, since the area of the first electrode 21 is increased, the capacitor 3b is likely to have a higher electrostatic capacity.

The porous body 15 can be obtained in a manner such that, for example, while a metal tantalum having a porous structure is in contact with a solution containing tellurium, anodic oxidation of the metal tantalum is performed. The metal tantalum having a porous structure can be obtained, for example, by an etching treatment of a metal tantalum foil or by sintering of a metal tantalum powder.

In the capacitor 3b, the second electrode 22 contains, for example, an electrolyte. The electrolyte includes, for example, at least one selected from the group consisting of an electrolyte solution, a solid electrolyte, and an electric conductive polymer. As an example of the electric conductive polymer, there may be mentioned a polypyrrole, a polythiophene, a polyaniline, or a derivative thereof. As the electrolyte, a manganese compound such as manganese oxide may also be used.

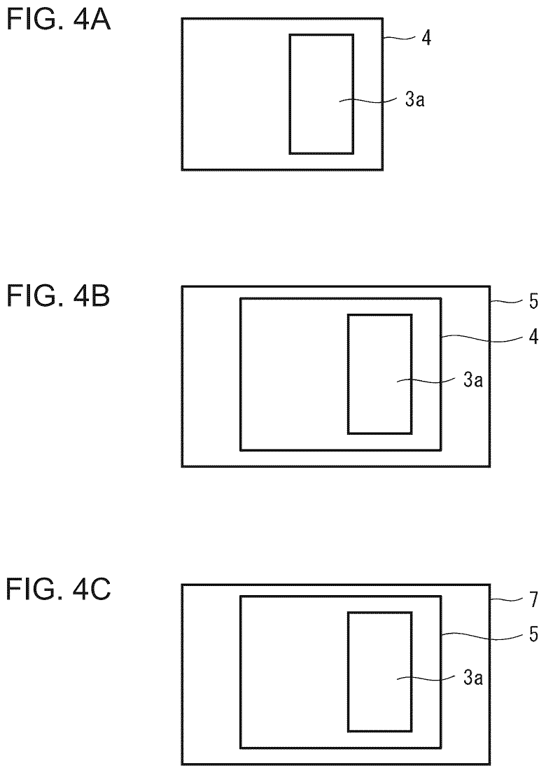

FIG. 4A is a schematic view showing one example of an electric circuit of the present disclosure. An electric circuit 4 includes the capacitor 3a. The electric circuit 4 may be either an active circuit or a passive circuit. The electric circuit 4 may also be any one of a discharge circuit, a smoothing circuit, a decoupling circuit, and a coupling circuit. Since including the capacitor 3a, the electric circuit 4 is likely to have desired performance. For example, in the electric circuit 4, noise is likely to be reduced. The electric circuit 4 may also include the capacitor 3b.

FIG. 4B is a schematic view showing one example of a circuit board of the present disclosure. As shown in FIG. 4B, a circuit board 5 includes the capacitor 3a. For example, in the circuit board 5, the electric circuit 4 including the capacitor 3a is formed. Since including the capacitor 3a, the circuit board 5 is likely to have desired performance. The circuit board 5 may be either an embedded board or a mother board. The circuit board 5 may also include the capacitor 3b.

FIG. 4C is a schematic view showing one example of an apparatus of the present disclosure. As shown in FIG. 4C, an apparatus 7 includes the capacitor 3a. For example, the apparatus 7 has the circuit board 5 including the capacitor 3a. Since including the capacitor 3a, the apparatus 7 is likely to have desired performance. The apparatus 7 may be any one of an electronic apparatus, a communication apparatus, a signal processing apparatus, and an electric power apparatus. The apparatus 7 may be any one of a server, an AC adaptor, an accelerator, and a flat panel display such as a liquid display device (LCD). The apparatus 7 may be any one of a USB charger, a solid state drive (SSD), an information terminal, such as a PC, a smartphone, or a tablet PC, and an Ethernet switch.

The apparatus 7 may also include the capacitor 3b.

### Appendixes

The above description has disclosed the following techniques.

### Technique 1

A dielectric comprises:
a first portion that contains tantalum oxide and tellurium and that is located at a surface of the dielectric; and
a second portion that contains tantalum oxide and that is covered with the first portion,
wherein a content of the tellurium in the first portion is higher than a content of tellurium in the second portion.

### Technique 2

In the dielectric according to technique 1,
the first portion has a first layered shape,
the second portion has a second layered shape, and
a thickness of the first portion is less than or equal to 24% of a sum of the thickness of the first portion and a thickness of the second portion.

### Technique 3

In the dielectric according to technique 1 or 2,
in the first portion, a content of tellurium at a first position apart from the surface in a direction perpendicular to the surface by a first distance is lower than a content of tellurium at a second position apart from the surface in the direction described above by a second distance that is shorter than the first distance.

### Technique 4

In the dielectric according to any one of techniques 1 to 3,
the tellurium contained in the first portion includes tetravalent tellurium.

### Technique 5

A capacitor comprises:
a first electrode;
a second electrode; and
a dielectric film disposed between the first electrode and the second electrode,
wherein the dielectric film contains the dielectric according to any one of techniques 1 to 4.

### Technique 6

In the capacitor according to technique 5,
the first electrode contains metal tantalum, and
the second portion is located between the first electrode and the first portion.

### Technique 7

An electric circuit comprises:
the capacitor according to technique 5 or 6.

### Technique 8

A circuit board comprises:
the capacitor according to technique 5 or 6.

### Technique 9

An apparatus comprises:
the capacitor according to technique 5 or 6.

### Technique 10

A method for manufacturing a dielectric, comprises:
bringing metal tantalum into contact with a solution containing tellurium, and performing anodic oxidation of the metal tantalum while the metal tantalum is in contact with the solution.

### EXAMPLES

Hereinafter, the present disclosure will be described in more detail with reference to Examples. In addition, the following examples are described by way of example, and the present disclosure is not limited to the following Examples.

### Example 1

A tantalum plate having a thickness of 0.1 mm was prepared as an anode. This tantalum plate had a rectangular shape having a short side of 10 mm and a long side of 50 mm in plan view. As a cathode, a tantalum foil having a surface area approximately several times larger than that of the tantalum plate was prepared. After ultrasonic washing was performed on the tantalum plate and the tantalum foil in acetone for 10 minutes, water washing was carried out. In an aqueous solution containing H₆TeO₆, the tantalum plate and the tantalum foil were disposed with a predetermined space therebetween. The concentration of H₆TeO₆ in the aqueous solution was 1 mol/L. Next, using an electric power device, a voltage was applied between the tantalum plate functioning as the anode and the tantalum foil functioning as the cathode in a constant voltage manner to cause an electrochemical reaction at the surface of the tantalum plate, so that anodic oxidation was performed. Accordingly, a dielectric film was formed on the tantalum plate. In the anodic oxidation, as the electric power device, a DC stabilized power supply was used, and a current during the formation of the dielectric film was measured by a digital multimeter. The voltage applied in the anodic oxidation was increased at a rate of 20V/min, and after reaching 80V, the voltage was maintained at 80 V for 90 minutes. After the voltage application, the dielectric film formed on the tantalum plate was washed with running water for 15 minutes. As described above, the dielectric film according to Example 1 was obtained.

### Example 2

Except for that the concentration of H₆TeO₆ in the aqueous solution was changed to 0.1 mol/L, a dielectric film according to Example 2 was obtained in a manner similar to that of Example 1.

### Example 3

Except for that the concentration of H₆TeO₆ in the aqueous solution was changed to 0.01 mol/L, a dielectric film according to Example 3 was obtained in a manner similar to that of Example 1.

### Comparative Example 1

Except for that an aqueous solution containing H₃PO₄ was used instead of using the aqueous solution containing H₆TeO₆, a dielectric film according to Comparative Example 1 was obtained in a manner similar to that of Example 1. The concentration of H₃PO₄ in this aqueous solution was 0.0017 mol/L.

### Elemental Composition Analysis

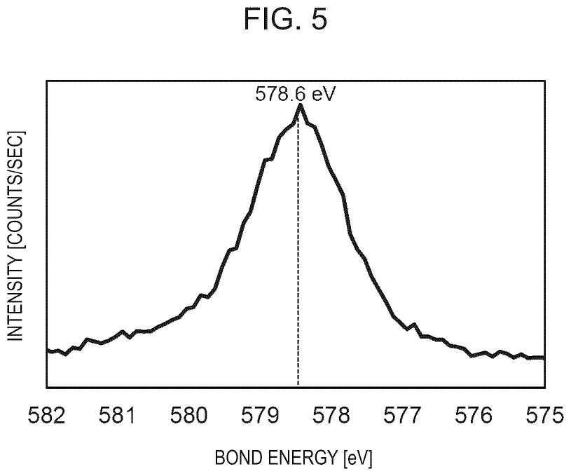

In order to perform a composition analysis of the dielectric film of each Example, an XPS measurement was performed using an XPS measurement apparatus PHI 5000 VersaProbe (manufactured by ULVAC-PHI, Inc.). In this measurement, as the characteristic X-ray, the MgKα line (1253.6 eV) was used. FIG. 5 is a graph showing the result of the XPS measurement of the dielectric film according to Example 2. In FIG. 5, the vertical axis indicates the intensity of photoelectrons, and the horizontal axis indicates the bond energy. In FIG. 5, fitting of the measurement data was performed by the least-square method, and a peak position (578.6 eV) of the graph shown in FIG. 5 was identified. Since this peak position is closed to the peak position of TeO₂, the oxidation number of tellurium contained in the dielectric film according to Example 2 is believed to be 4 which is smaller than a maximum oxidation number of 6 by 2. In addition, from the results of the XPS measurements of the dielectric films according to Examples 1 and 3, the oxidation number of the tellurium contained in each dielectric film is also believed to be 4.

### Composition Analysis in Depth Direction

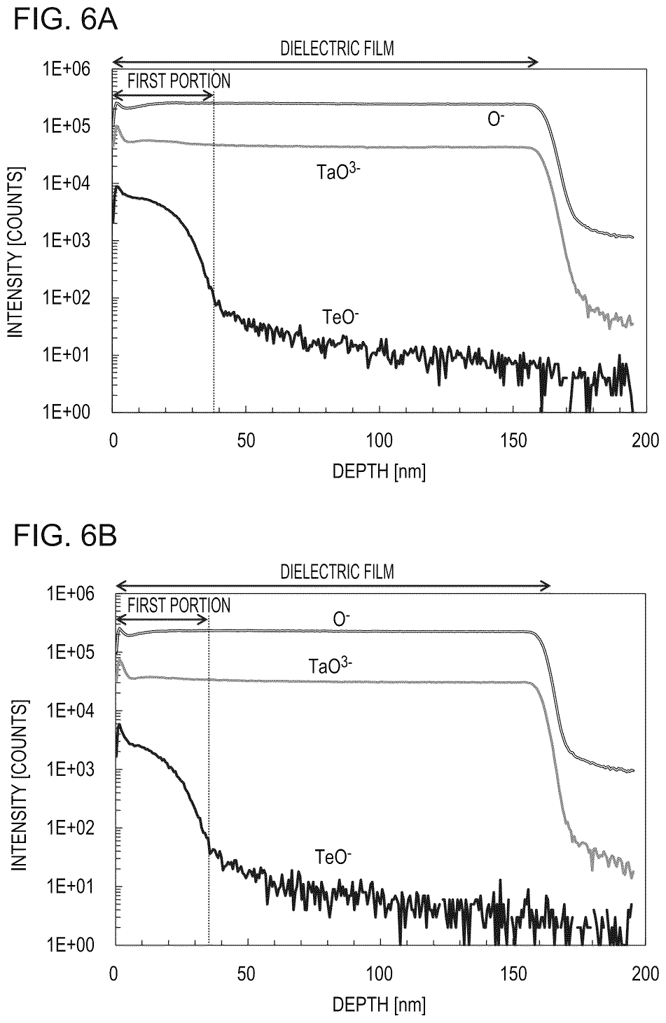

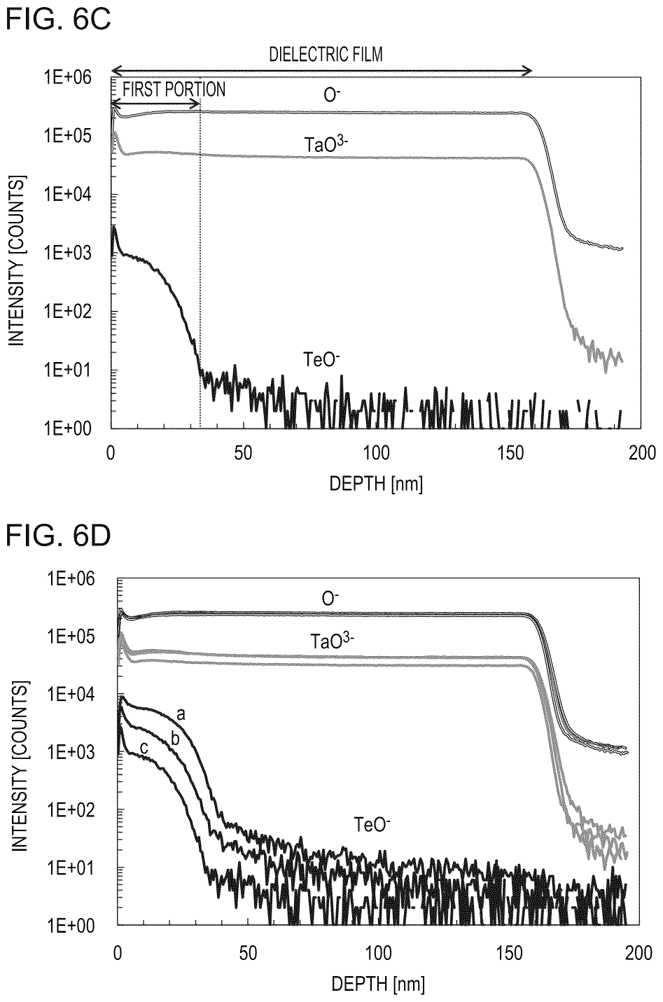

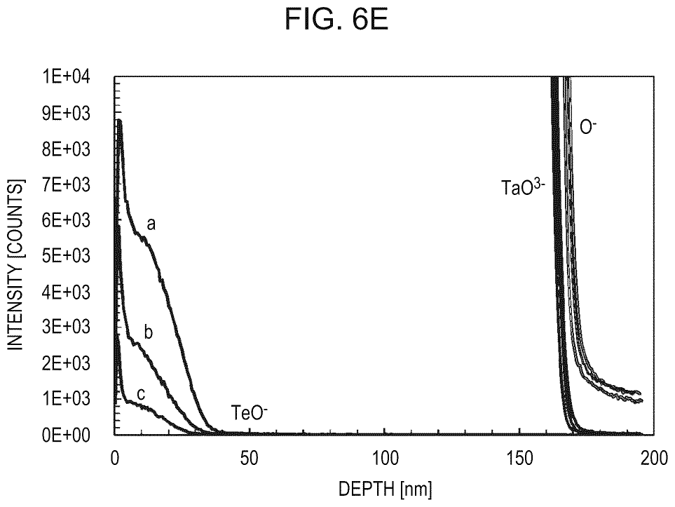

By the use of a TOF-SIMS apparatus, TOF. SIMS5, manufactured by ION-TOF, the composition analysis of the dielectric film according to each Example was performed by a TOF-SIMS. In the TOF-SIMS, as ion beams, Bi³⁺ beams accelerated by a voltage of 30 kV were used. As the sputtering ion species, Cs⁺ was used. The depth was determined based on the sputtering rate. FIGS. 6A, 6B, and 6C are graphs, each showing the relationship between signal intensities of tellurium oxide ions (TeO⁻), tantalum oxide ions (TaO³⁻), and oxygen ions (O⁻) of the dielectric film measured by the TOF-SIMS and the depth thereof, according to Examples 1, 2, and 3, respectively. FIGS. 6D and 6E are graphs in each of which the relationships shown in FIGS. 6A, 6B, and 6C measured using the TOF-SIMS are collectively shown. In FIGS. 6A to 6E, the vertical axis indicates the signal intensity of each ion measured by the TOF-SIMS, and the horizontal axis indicates the depth of the dielectric film.

According to FIGS. 6A to 6C, it is understood that the signal intensities of TaO³⁻ and O⁻ are approximately constant in a depth range of from 0 nm to approximately 160 nm, and that in the range described above, tantalum oxide is contained. On the other hand, the signal intensity of TeO⁻ is decreased as the depth is increased in a range of from 0 nm to a predetermined depth, and the predetermined depth is approximately from 32 nm to 38 nm. In addition, the signal intensity of TeO⁻ is extremely decreased in a depth range of approximately 40 nm or more. Hence, it is understood that the dielectric film containing tantalum oxide is formed to have a thickness of approximately 160 nm, and that although tellurium is present in the first portion which is located between the surface of the dielectric film and the predetermined depth therefrom and which has a thickness of approximately 32 nm to 38 nm, tellurium is hardly present in the other portion corresponding to the second portion.

In FIGS. 6A to 6C, although the signal intensities of TaO³⁻ and O⁻ are approximately constant in a depth range of from 0 nm to approximately 160 nm, the signal intensity of TeO⁻ is decreased as the depth is increased in a range corresponding to the first portion and is extremely decreased in a depth range of approximately 40 nm or more corresponding to the second portion. From the phenomenon described above, it is understood that the content of tellurium in the first portion is higher than the content of tellurium in the second portion.

In FIGS. 6D and 6E, graphs a, b, and c indicate the signal intensities of TeO⁻ of the dielectric films according to Examples 1, 2, and 3, respectively. According to FIGS. 6D and 6E, it is understood that for example, when the concentration of H₆TeO₆ in the aqueous solution is adjusted, the thickness of a portion of the dielectric film in which tellurium is contained and the content of tellurium in the portion described above can be adjusted.

### Dielectric Characteristics

By the use of the tantalum plates on which the dielectric films according to respective Examples and Comparative Example 1 were formed, an alternating current impedance measurement was performed. This measurement was performed in a phosphoric acid aqueous solution at a concentration of 1 mol/L using a potentiostat and a galvanostat. The amplitude of the voltage was controlled at 100 mV, and an alternating voltage was applied between a pair of electrodes including the tantalum plate in a range of from 0.1 Hz to 1 MHz. Based on the result of the alternating current impedance measurement, the electrostatic capacity of the capacitor including the dielectric film was calculated. The alternating current impedance measurement was performed in an environment at room temperature.

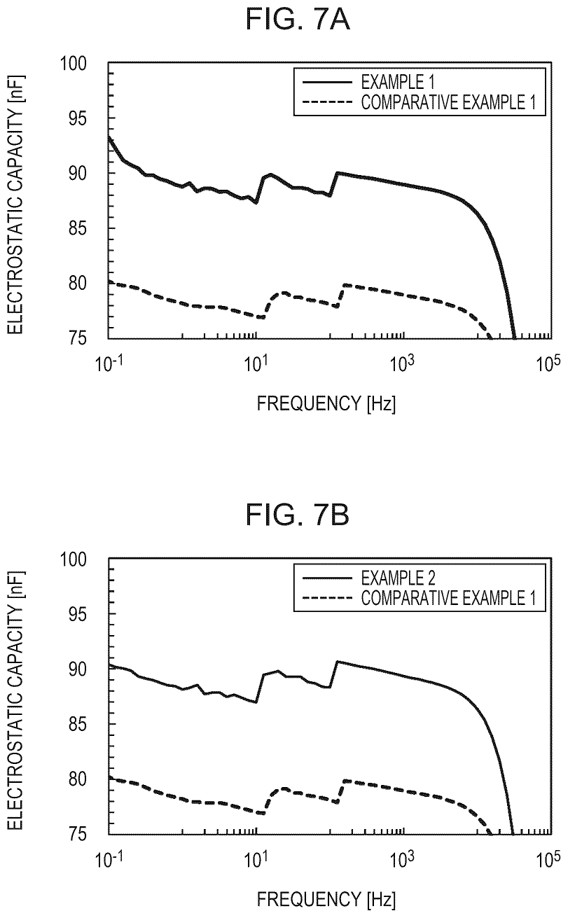

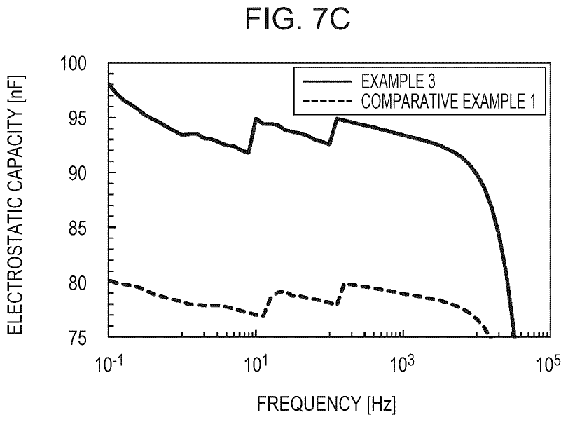

FIG. 7A is a graph showing the relationships each between the frequency and the electrostatic capacity of the capacitor including the dielectric film, according to Example 1 and Comparative Example 1. FIG. 7B is a graph showing the relationships each between the frequency and the electrostatic capacity of the capacitor including the dielectric film, according to Example 2 and Comparative Example 1. FIG. 7C is a graph showing the relationships each between the frequency and the electrostatic capacity of the capacitor including the dielectric film, according to Example 3 and Comparative Example 1. In FIGS. 7A to 7C, the vertical axis indicates the electrostatic capacity, and the horizontal axis indicates the frequency of an alternating current voltage. As shown in FIGS. 7A to 7C, the electrostatic capacity of the capacitor including the dielectric according to each of Examples 1, 2, and 3 is larger than the electrostatic capacity of the capacitor including the dielectric according to Comparative Example 1. As described above, to contain tellurium at a portion which forms the surface of the dielectric containing tantalum oxide suggests advantages in view of increase of the electrostatic capacity of the capacitor. As described above, since the oxidation number of tellurium contained in the dielectric is believed to be 4, the structural asymmetry is generated, and the polarization is likely to occur, so that it is assumed that a high electrostatic capacity can be realized thereby.

The dielectric according to the present disclosure can be used for electronic devices such as a capacitor.

What is claimed is:

1. A dielectric comprising:
a first portion that contains tantalum oxide and tellurium and that is located at a surface of the dielectric; and
a second portion that contains tantalum oxide and that is covered with the first portion,
wherein a content of the tellurium in the first portion is higher than a content of tellurium in the second portion.

2. The dielectric according to claim 1, wherein
the first portion has a first layered shape,
the second portion has a second layered shape, and
a thickness of the first portion is less than or equal to 24% of a sum of the thickness of the first portion and a thickness of the second portion.

3. The dielectric according to claim 1,
wherein, in the first portion, a content of tellurium at a first position apart from the surface in a direction perpendicular to the surface by a first distance is lower than a content of tellurium at a second position apart from the surface in the direction by a second distance that is shorter than the first distance.

4. The dielectric according to claim 1,
wherein the tellurium contained in the first portion includes tetravalent tellurium.

5. A capacitor comprising:
a first electrode;
a second electrode; and
a dielectric film disposed between the first electrode and the second electrode,
wherein the dielectric film contains the dielectric according to claim 1.

6. The capacitor according to claim 5, wherein
the first electrode contains metal tantalum, and
the second portion is located between the first electrode and the first portion.

7. An electric circuit comprising:
the capacitor according to claim 5.

8. A circuit board comprising:
the capacitor according to claim 5.

9. An apparatus comprising:
the capacitor according to claim 5.

10. A method for manufacturing a dielectric, the method comprising:
bringing metal tantalum into contact with a solution containing tellurium, and
performing anodic oxidation of the metal tantalum while the metal tantalum is in contact with the solution.
